(19) United States
(12) Patent Application Publication
(10) Pub. No.: US 2022/0041088 A1
(43) Pub. Date: Feb. 10, 2022

(54) SAFETY STRAP APPARATUS

(71) Applicant: Carlos Eduardo Martinez, Jackson Heights, NY (US)

(72) Inventor: Carlos Eduardo Martinez, Jackson Heights, NY (US)

(21) Appl. No.: 17/302,557

(22) Filed: May 6, 2021

Related U.S. Application Data
(60) Provisional application No. 62/706,169, filed on Aug. 4, 2020.

(51) Int. Cl. B60N 3/02

(52) U.S. Cl. CPC B60N 3/023

(57) ABSTRACT

A commuter safety strap apparatus may serve as personal protection equipment for a user of public transportation vehicles. The apparatus may be portable, and may be removably installed on a safety rail of a public transportation vehicle or other structure when needed. The commuter safety strap apparatus may enable use of an unsanitized safety rail without touching it, to provide stability while the public transportation vehicle is in movement, so that the user may enjoy the ride to work, back home, or to another location.

### CROSS-REFERENCE TO RELATED APPLICATION

This application claims the benefit of priority of U.S. Provisional Application No. 62/706,169, filed Aug. 4, 2020, the contents of which are herein incorporated by reference.

### BACKGROUND OF THE INVENTION

The present invention relates to safety devices, and more particularly, to a safety strap apparatus.

The coronavirus outbreak has changed the way people interact with objects. Hygiene has become an increasingly important concern. People need personal protection equipment (PPE) of various types. There are no personal protective equipment devices for use by users of public transportation. Many people touch the safety devices on public transportation. There is no way to use public transportation without touching safety rails and other objects on a subway train, a bus or other commuter vehicle.

In the past, strap hangers were part of the commuter experience. While strap hangers were previously provided on public transportation, they were removed from subway cars and buses many years ago.

Whether rails, strap hangers, or other hand holds, in order to use safety devices on public transportation, it is necessary for many people to touch the safety devices on public transportation. These safety devices are not sanitized.

As can be seen, there is a need for a device that provides safety and allows the user of public transportation to avoid touching objects therein.

There is a need for a device that assists the user of public transportation to have a stable, safe ride, while also being sanitary.

In addition, there is a need for a device which may provide additional functions and capabilities to a user of public transportation during the commute.

Accordingly, there is a need for a solution to at least one of the aforementioned problems.

### SUMMARY OF THE INVENTION

In one aspect of the present invention, a safety strap apparatus is disclosed. The safety strap apparatus may be portable and may provide a safer way to commute. The safety strap apparatus may provide a way for a user to avoid touching the safety rails of public transportation vehicles, so that the user no longer has to hold un-sanitized metal handrails while riding or standing in public transportation vehicles. The safety strap apparatus may comprise a device which serves as personal protection equipment on public transportation and assists the user in avoiding touching objects on public transportation. The safety strap apparatus of the present invention may operate to assist the commuter in maintaining balance while standing and riding in a public transportation vehicle, to reduce the effect of the forces encountered by a commuter while standing or riding in the public transportation vehicle such as braking, stopping, or the like. The safety strap apparatus may allow the user to safely use the safety rails on public transportation without touching them, so that the user may enjoy the ride to work or back home.

The safety strap apparatus may be portable and may include a first portion adapted for removable attachment to a bar of a public transportation vehicle by a user; and a second portion operably connected to the first portion, the second portion configured to be held by the user to assist the user in maintaining the user's balance while standing or riding in the public transportation vehicle.

In some embodiments, the first portion and the second portion may be integrally formed. The first portion and the second portion may be made of any suitable material. In one embodiment, the first portion and second portion may comprise a canvas material. In a further embodiment, the first portion and the second portion may comprise a piece of 1½ inch-wide canvas webbing, having a length of between about 25-40 inches. In a still further embodiment, the first portion and second portion may comprise a piece of 1½ inch-wide canvas webbing having a length of about 27 inches.

In some embodiments, the second portion comprises at least one strap. In other embodiments, the second portion may comprise a hand grip. In some embodiments, the second portion may be connected to the first portion by any suitable means, such as, for example without limitation, one or more of the following: stitching, adhesive, adhesive tape, spring closure, buckle, clasp, hook and loop fastener, D-ring, O-Ring, square ring, and combinations thereof. In one embodiment, the second portion may include a handle which may be pivotally mounted.

In one aspect of the present invention, a safety strap assembly for attachment to a safety rail of a public transportation vehicle may comprise: an upper strap portion being securely and removably attachable to the safety rail of the public transportation vehicle by the user of the safety strap assembly; and a lower strap portion attached to the upper strap portion, the lower strap portion constructed and arranged to be held by the user to assist the user in maintaining the user's balance while standing or riding in the public transportation vehicle. In a further aspect of the present invention, the commuter safety apparatus may easily be installed and removed from the public transportation vehicle when the user is done riding.

In one aspect, the upper strap portion and lower strap portion may comprise a single unitary construction. The upper strap portion and the lower strap portion may be of any suitable material.

In a further aspect, the lower strap portion may be a separate element permanently or removably attachable to the upper strap portion.

Advantageously, the safety strap apparatus in accordance with the present invention may further include added features or components to provide added functionality for multiple purposes and uses during travel, while installed on the vehicle, and even during travel from the public transportation vehicle to the homes.

In additional aspects, the safety strap apparatus of the present invention may provide additional functions and capabilities. For example, without limitation, the device may be used as a carrying strap for grocery bags or as a comfort strap for a briefcase or other carry-on.

In a further aspect, the safety strap apparatus may comprise a strap for use by commuters which may provide a safer way to commute during the pandemic and phases 1, 2 and 3 of cities reopening.

During the past, particularly during the 1990s, New York City subways had metal hand straps. Such metal hand straps had specific limitations and disadvantages, including that they were not sanitized, and they could not be portable. Accordingly, in one aspect, the safety strap apparatus of the present invention may be sanitized. In a further aspect, the safety strap apparatus of the present invention may be laundered or machine washable. In a still further aspect, the safety strap apparatus of the present invention may be portable, and removably installed on a safety rail of a public transportation vehicle.

In a further aspect, the safety strap apparatus may comprise a strap made of any suitable material. Nonlimiting examples of suitable materials may include machine washable fabrics of nylon, soft polyester or other synthetic fabrics, natural fabrics such as cotton, linen, rayon, or leather or suede. In some embodiments, the safety strap apparatus may comprise at least one strap portion. In other embodiments, the safety strap apparatus may comprise a first strap portion and a second strap portion which may be made of any suitable material and have any suitable dimensions. In one aspect, the safety strap apparatus may comprise a single strap which may be made of 1½ inch-wide canvas webbing, and may have a length of between about 25 and 40 inches. In some embodiments, the safety strap apparatus may comprise a single strap which may be made of 1½ inch-wide canvas webbing, and may have a length of about 36 inches. In other embodiments, the safety strap apparatus may comprise a single strap which may be made of 1½ inch-wide canvas webbing, and may have a length of about 27 inches.

In an exemplary embodiment of the present invention commuters may use the safety strap apparatus of the present invention to avoid holding metal rails with their bare hands. The safety strap apparatus may easily be installed and removed from the public transportation vehicle when the user is done riding. The safety strap apparatus of the present invention may be used by a method including the steps of providing a safety strap apparatus, and attaching the apparatus to any horizontal or vertical rail in any commuter vehicle such as, for example without limitation, trains or buses. The user may tie a “Cow Hitch Knot” or “Girth Knot” to create an anchor point, and pull down to adjust tension. When it is time to get off the train or bus, the user may easily remove the safety strap apparatus by placing a finger through the knot and pulling downward to unfasten the commuter strap from the public transportation vehicle.

The safety strap apparatus may be machine washable, and may be disinfected between uses. The safety strap apparatus may provide a clean safe way to use public transportation.

These and other features, aspects and advantages of the present invention will become better understood with reference to the following drawings, description and claims.

### BRIEF DESCRIPTION OF THE DRAWINGS

The preferred embodiment of the claimed subject matter will hereinafter be described in conjunction with the appended drawings provided to illustrate and not to limit the scope of the claimed subject matter, where like designations denote like elements, and in which:

FIG. 1 is a perspective view of the invention in use;

FIG. 2 is a perspective view of the invention;

FIG. 3 is a perspective view of the invention;

FIG. 4 is a section view of the invention, taken along line 4-4 in FIG. 2;

FIG. 5 shows an alternative embodiment of the invention;

FIG. 6 shows an alternative embodiment of the invention;

FIG. 7 shows an alternative embodiment of the invention;

FIG. 8 shows an alternative embodiment of the invention;

FIG. 9 shows an alternative embodiment of the invention;

FIG. 10A is the first step of the installation process;

FIG. 10B is the second step of the installation process;

FIG. 10C is the third step of the installation process;

FIG. 11A is the first step of the removal process;

FIG. 11B is the second step of the removal process; and

FIG. 11C is the third step of the removal process.

It is to be understood that like reference numerals refer to like parts throughout the several views of the drawings.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

As used herein, “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, as there is no intention to be bound by any express or implied theory presented in the preceding technical field, background, brief summary or the following detailed description, it is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Broadly, one embodiment of the present invention may provide a removable safety strap apparatus for use in a public transportation vehicle. The safety strap apparatus may be portable and may be removably secured to the public transportation vehicle when needed.

Referring to the Figures, in an exemplary embodiment the safety strap apparatus referred to generally at 10 may comprise a first portion adapted for removable attachment to a safety rail or safety bar 26 of a public transportation vehicle by a user; and a second portion operably connected to the first portion, the second portion configured to be held by the user to assist the user in maintaining the user's balance while standing or riding in the public transportation vehicle. In some embodiments, the first portion may be a support portion, to which the lower portion may be removably attached.

In some embodiments, as seen at FIGS. 1-4, the first portion and the second portion may be integrally formed. The first portion and the second portion may comprise a piece of 1½ inch-wide canvas webbing, having a length of between about 25-40 inches. In one embodiment, the length may be about 36 inches. In another embodiment, the length may be about 27 inches.

The safety strap apparatus may comprise any suitable material. Nonlimiting examples of suitable materials may include machine washable fabrics of nylon, soft polyester or other synthetic fabrics, natural fabrics such as cotton, linen, rayon, or leather or suede. In some embodiments, the safety strap apparatus may comprise at least one strap portion. In other embodiments, the safety strap apparatus may comprise a first strap portion and a second strap portion which may be made of any suitable material and have any suitable dimensions.

As seen at FIGS. 1-4, the safety strap apparatus 10, may comprise a single strap which may be made of 1½ inch-wide canvas webbing, and may have a length of between about 25 and 40 inches. In some embodiments, the safety strap apparatus may comprise a single strap which may be made of 1½ inch-wide canvas webbing, and may have a length of about 36 inches. In other embodiments, the safety strap apparatus may comprise a single strap which may be made of 1½ inch-wide canvas webbing, and may have a length of about 27 inches. The single strap may have a first end and a second end, joined in overlapping manner and secured together by any suitable securement means. Nonlimiting examples of suitable securement means to secure the ends of the strap may include, stitching, adhesive, tape, hook and loop elements, or rivets.

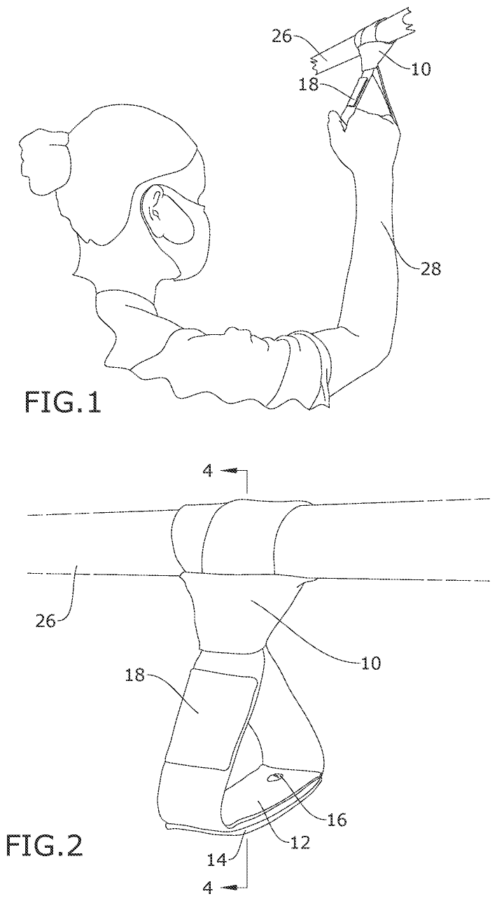

The safety strap apparatus 10 may include a top portion and a bottom portion, an interior surface and an exterior surface. The safety strap apparatus 10 bottom portion may define a grab handle having an interior grab handle 12 and an exterior grab handle 14. In the embodiment shown at FIG. 2, it can be seen that the securement means joining the first end and the second end of the strap includes at least one rivet 16. In one embodiment, as seen at FIG. 4, the securement means comprises a pair of rivets 16. At FIG. 4, it can also be seen that the interior grab handle 12, and exterior grab handle 14 may comprise a reinforcement panel. The strap may further be provided with a logo pad element 18 which may also comprise a finger or thumb grip pad 18 in addition to a surface on which product indicia or a logo may be provided.

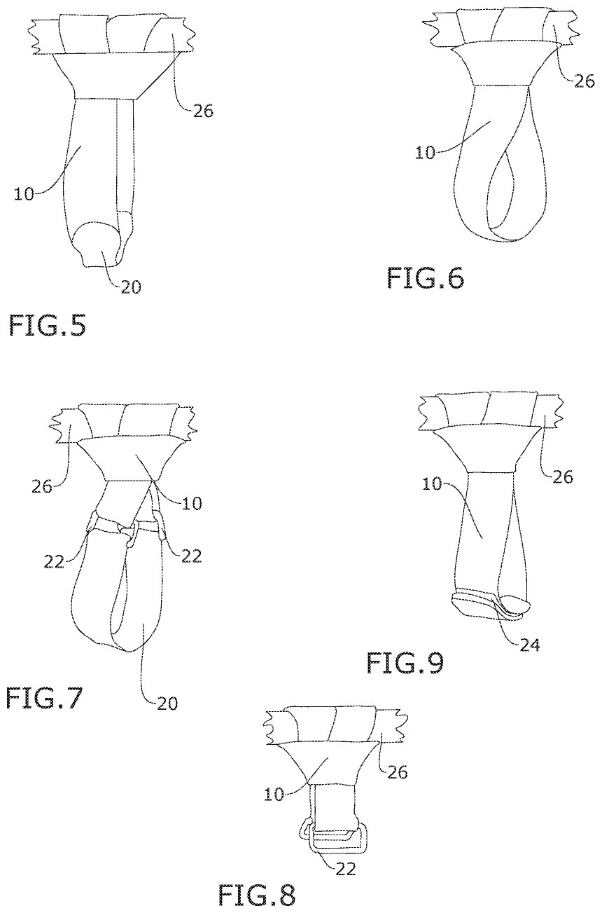

In some embodiments, the second portion may comprise at least one strap. In some embodiments, the second portion may include a gripping portion and a reinforcement portion as seen at FIGS. 1-4. It is also seen at FIG. 5, element 20 that the handle 20 is both a single handle and reinforcement element. It is also seen at FIG. 7, element 20 that a single handle may be provided.

In some embodiments, the second portion or lower portion may have a gripping portion which further comprises a handle which may be mounted on at least one pivot.

The safety strap apparatus may be made of any suitable material by any suitable process. The safety strap apparatus may be washable or may be disinfected after use. Advantageously, in some embodiments, at least a portion of the safety strap apparatus may be made of a plastic material or of machine washable fabrics selected from nylon, soft polyester, synthetic fabrics, natural fabrics such as cotton, linen, rayon, leather or suede, and combinations thereof.

In one aspect of the present invention, the safety strap apparatus may be portable and may include a first portion adapted for removable attachment to a bar of a public transportation vehicle by a user; and a second portion operably connected to the first portion, the second portion configured to be held by the user to assist the user in maintaining the user's balance while standing or riding in the public transportation vehicle.

In some embodiments, the first portion and the second portion are integrally formed and may comprise a unitary construction. The first portion and the second portion may comprise a piece of 1½ inch-wide canvas webbing, having a length of 27 inches.

In some embodiments, the safety strap apparatus may comprise any suitable material, nonlimiting examples of which may include machine washable fabrics of nylon, soft polyester or other synthetic fabrics, natural fabrics such as cotton, linen, rayon, or leather or suede. In some embodiments, the safety strap may comprise at least one strap portion. In other embodiments, the safety strap apparatus may comprise a first strap portion and a second strap portion which may be made of any suitable material and have any suitable dimensions. In one aspect, the safety strap apparatus may comprise a single strap which may be made of 1½ inch-wide canvas webbing, and may have a length of between about 25 and 40 inches. In some embodiments, the safety strap apparatus may comprise a single strap which may be made of 1½ inch-wide canvas webbing, and may have a length of about 36 inches. In other embodiments, the safety strap apparatus may comprise a single strap which may be made of 1½ inch-wide canvas webbing, and may have a length of about 27 inches.

In a further aspect, the lower strap portion may be a separate element permanently or removably attachable to the upper strap portion, best seen at FIG. 7, element 20. In some embodiments, the second portion comprises at least one strap. In other embodiments, the second portion may comprise a hand grip or a handle (also as seen at element 20 of FIG. 7). In some embodiments, the second portion may be connected to the first portion by any suitable means, such as, for example, a connector 22. In an exemplary embodiment, connector 22 may be a square ring 22 as seen at FIGS. 7 and 8. The connector 22 is shown at FIG. 7 with a handle attached thereto. The connector is shown at FIG. 8 with as rings 22 having no additional handle attached thereto, providing an element to which any accessory may be attached. As seen at FIG. 9, the connector may comprise a hook and loop fastener 24. Nonlimiting examples of suitable connectors may include stitching or adhesive, as may be seen at FIG. 5. Additional nonlimiting examples of a suitable connectors may include tape, adhesive, stitching, spring closure, buckle, clasp, hook and loop fastener, D-ring, O-Ring, square ring, and combinations thereof. Nonlimiting examples of some different configurations of the commuter safety strap apparatus, which include such elements, are shown at FIGS. 1-11. In one embodiment, the second portion may include a handle 20. In some embodiments the handle may be pivotally mounted.

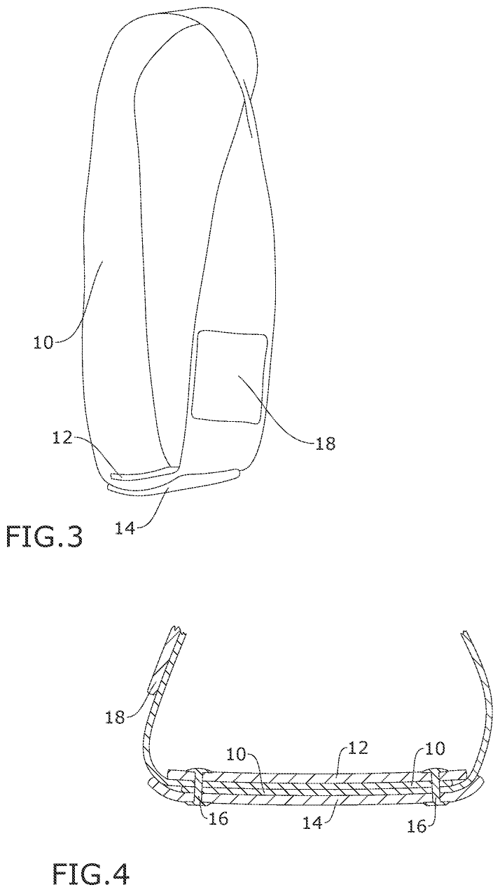

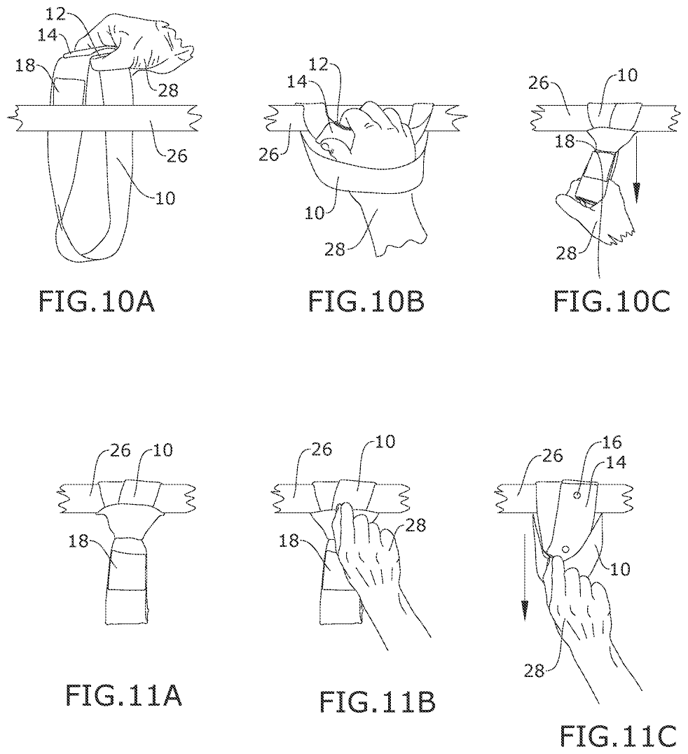

It can be seen that in one exemplary embodiment, the safety strap apparatus 10 may comprise a simple strap in the form of a loop as seen at FIG. 3, that a user may tie in a “Cow Hitch” knot, on a public transportation vehicle safety rail or other structure 26, whereby in use, a first portion thereof may comprise an attachment portion, and a second portion thereof may comprise a hand grip or handle, as shown at FIGS. 1-2. The process for attachment or installation of the safety strap apparatus 10 to a structure 26 is best seen at FIGS. 10A-C. The process for detachment or removal of the safety strap apparatus from the structure 26 is best seen at FIGS. 11A-C.

The safety strap apparatus and portions thereof may be made of any suitable material. Nonlimiting examples of suitable materials may include machine washable fabrics of nylon, soft polyester or other synthetic fabrics, natural fabrics such as cotton, linen, rayon, or leather or suede, plastic materials, rubber or silicone.

The safety strap apparatus may comprise a unitary strap made of any suitable material. Nonlimiting examples of suitable materials may include machine washable fabrics of nylon, soft polyester or other synthetic fabrics, natural fabrics such as cotton, linen, rayon, or leather or suede. In some embodiments, the safety strap may comprise at least one strap portion. In other embodiments, the safety strap may comprise a first strap portion and a second strap portion which may be made of any suitable material and have any suitable dimensions. In one aspect, the safety strap may comprise a single strap which may be made of 1½ inch-wide canvas webbing, and may have a length of between about 25 and 40 inches. In some embodiments, the safety strap may comprise a single strap which may be made of 1½ inch-wide canvas webbing, and may have a length of about 36 inches. In other embodiments, the safety strap may comprise a single strap which may be made of 1½ inch-wide canvas webbing, and may have a length of about 27 inches.

In an exemplary embodiment, the safety strap may comprise a 1½ inch-wide canvas webbing, having a length of 27 inches. In some embodiments, handles, gripping portions, and reinforcement portions may comprise fabrics, leather, suede, pleather, plastic, rubber, or any suitable material.

In an exemplary embodiment, the present invention may provide a safety strap apparatus for use by at least one person on a vehicle safety rail or other structure, the commuters safety strap apparatus comprising an upper strap portion constructed and arranged for removable securement or attachment to the vehicle safety rail or other structure; and at least one lower strap portion operably connected to the upper strap portion, the at least one lower strap portion constructed and arranged to provide a loop which may be grasped by a person, or in which the person may rest a hand or a wrist, the strap apparatus providing a way for the person to maintain balance and stability while standing or riding in the vehicle or other structure.

The at least one lower strap portion may comprise one lower strap portion, and the commuter safety strap apparatus may comprise a unitary strap stitched or sewn to form the upper strap portion and the lower strap portion thereof. In some embodiments, the at least one lower strap portion may be removably attached to the upper strap portion. In some embodiments, the at least one lower strap portion may be pivotally mounted to the upper strap portion. In some embodiments, the at least one lower strap portion may comprise a handle. In some embodiments the handle may be pivotally mounted to the lower strap portion. In some embodiments the at least one lower portion may comprise two strap portions or two handles, for use by two users at once. Alternatively, two safety strap apparatuses may be connected together, a first safety strap apparatus being connected to a safety rail of a public transportation vehicle or other structure, and a second safety strap apparatus having its top portion connected to the lower portion of the first safety strap apparatus.

In an exemplary embodiment of the present invention commuters may use the safety strap apparatus of the present invention to avoid holding metal rails with their bare hands. Advantageously, the safety strap apparatus may be safely and quickly installed and removed. With reference to FIGS. 10A-C and FIGS. 11A-C, in an exemplary embodiment, the present invention may provide a method for using the safety strap apparatus to make a public transportation vehicle conducive for providing a grip to a commuter during a ride on the public transportation vehicle. The method may comprise the steps of: providing the safety strap apparatus as seen at FIG. 10A; securing the safety strap apparatus to any safety rail of the public transportation vehicle (including but not limited to horizontal and vertical safety rails) as seen at FIG. 10B, by forming a “Cow Hitch Knot” or a “Girth Knot” to create an anchor point and then pulling down to adjust the tension as seen at FIG. 10C, using the safety strap apparatus to provide stability and balance during a ride on the commuter vehicle as seen at FIG. 1; and removing the safety strap apparatus from the safety rail of the public transportation vehicle at the end of the ride as seen at FIGS. 11A-C. When it is time to disembark from the public transportation vehicle, the safety strap apparatus may be easily removed from the safety rail of the public transportation vehicle by the user at the end of the ride, as is best seen at FIGS. 11A-C, by placing the user's finger through the knot as shown at FIG. 11B, and pulling downward as seen at FIG. 11C, to unfasten the commuter strap from the safety rail of the public transportation vehicle.

In a further embodiment, the safety strap apparatus may be machine washable, and the method may include the additional step of washing or disinfecting the safety strap apparatus after each use, each commute, or between uses.

Advantageously, the safety strap apparatus may further include added features or components to provide added functionality for multiple purposes and uses during travel, while installed on the vehicle, and even during travel from the public transportation vehicle to the homes. The safety strap apparatus may be used as a multipurpose device. For example, without limitation, in one embodiment, the safety strap apparatus may provide a hand grip for one or more users. In one embodiment, the safety strap apparatus may be used as a carrier for grocery bags or other items.

In summary, in an exemplary embodiment, the present invention is directed to a safety strap apparatus which may be used as personal protection equipment to provide stability and protection to users of public transportation. The safety strap apparatus may be portable, and may be removably secured to a safety rail on public transportation such as subway cars, buses or other public transportation vehicles, when needed. The safety strap apparatus may be used by users of public transportation vehicles to protect themselves from having to touch unsanitized metal public transportation vehicle safety rails, and to hold themselves and maintain their balance while the public transportation vehicles are in movement. The safety strap apparatus is a solution which provides a clean and safe option which may provide users of public transportation a more enjoyable ride on public transportation vehicles for commuting to work or back home, or for other purposes.

It should be understood, of course, that the foregoing relates to exemplary embodiments of the invention and that modifications, variations and changes in detail may be made without departing from the spirit and scope of the invention as set forth in the following claims.

What is claimed is:

1. A commuter safety apparatus comprising:
a first portion adapted for removable attachment to a bar of a public transportation vehicle by a user; and
a second portion operably connected to the first portion, the second portion configured to be held by the user to assist the user in maintaining the user's balance while standing or riding in the public transportation vehicle.

2. The commuter safety apparatus of claim 1 wherein the first portion and the second portion are integrally formed.

3. The commuter safety apparatus of claim 2 wherein the first portion and the second portion comprise a piece of 1½ inch-wide canvas webbing, having a length of 27 inches.

4. The commuter safety apparatus of claim 2 comprising a single unitary piece comprising a strap in the form of a loop constructed and arranged for removable attachment to a bar of a public transportation vehicle.

5. The commuter safety apparatus of claim 4 wherein the unitary portion comprise a piece of 1½ inch-wide canvas webbing, having a length of 27 inches.

6. The commuter safety strap apparatus of claim 1 wherein the second portion comprises at least one strap.

7. The commuter safety strap apparatus of claim 1 wherein the second portion comprises a pivotally mounted handle.

8. The commuter safety strap apparatus of claim 1 which is machine washable.

9. The commuter safety strap apparatus of claim 1 wherein at least a portion of the apparatus is made of machine washable fabrics selected from nylon, soft polyester, synthetic fabrics, natural fabrics such as cotton, linen, rayon, leather or suede, and combinations thereof.

10. A strap apparatus for use by at least one person on a vehicle safety rail or other structure, the strap apparatus comprising:
an upper strap portion constructed and arranged for removable securement or attachment to the vehicle safety rail or other structure; and
at least one lower strap portion operably connected to the upper strap portion, the at least one lower strap portion constructed and arranged to provide a loop which may be grasped by a person, or in which the person may rest a hand or a wrist, the strap apparatus providing a way for the person to maintain balance and stability while standing or riding in the vehicle or other structure.

11. The strap apparatus of claim 10 wherein the at least one lower strap portion comprises one lower strap portion, and the strap apparatus comprises a unitary strap stitched or sewn to form the upper strap portion and the lower strap portion thereof.

12. The strap apparatus of claim 10 wherein the at least one lower strap portion is removably attached to the upper strap portion.

13. The strap apparatus of claim 10 wherein the at least one lower strap portion is pivotally mounted to the upper strap portion.

14. The strap apparatus of claim 10 wherein the at least one lower strap portion comprises a handle.

15. The strap apparatus of claim 10 made of materials which are machine washable.

16. A method for making a commuter vehicle conducive for providing a grip to a commuter during a ride on the commuter vehicle, the method comprising the steps of:
providing the strap apparatus of claim 10;
securing the strap apparatus to a safety rail of the commuter vehicle by forming a cow hitch knot;
using the strap apparatus to provide stability and balance during the ride on the commuter vehicle; and
removing the strap apparatus from the safety rail of the commuter vehicle at the end of the ride.

17. The method of claim 16 wherein the strap apparatus is machine washable, and the method further comprises the step of machine washing the strap apparatus after use.
